(19) United States
(12) Patent Application Publication
(10) Pub. No.: US 2014/0098798 A1
(43) Pub. Date: Apr. 10, 2014

(54) UPLINK TIMING CONTROL TO REDUCE CALL DROP

(71) Applicant: QUALCOMM Incorporated, San Diego, CA (US)

(72) Inventors: Aamod Dinkar KHANDEKAR, San Diego, CA (US); Surendra BOPPANA, San Diego, CA (US); Insung KANG, San Diego, CA (US); Diwaker SINGH, Hyderabad (IN)

(73) Assignee: QUALCOMM Incorporated, San Diego, CA (US)

(21) Appl. No.: 14/049,695

(22) Filed: Oct. 9, 2013

Related U.S. Application Data
(60) Provisional application No. 61/712,081, filed on Oct. 10, 2012.

(51) Int. Cl. H04W 56/00

(52) U.S. Cl. CPC H04W 56/0035
USPC 370/336

(57) ABSTRACT

A user equipment (UE) may employ Timing Advance (TA) reporting to detect possible error conditions during communication between a base station and the UE. In some instances, the UE receives commands to change a timing advance value. The UE declares an error condition when a timing advance value compared with a reference timing advance value changes more than a threshold amount during a specified time period.

### CROSS-REFERENCE TO RELATED APPLICATION

This application claims the benefit under 35 U.S.C. §119(e) to U.S. Provisional Patent Application No. 61/712,081 entitled UPLINK TIMING CONTROL TO REDUCE CALL DROP, filed on Oct. 10, 2012, in the names of KHANDEKAR, et al., the disclosure of which is expressly incorporated by reference herein in its entirety.

### BACKGROUND

1. Field

Aspects of the present disclosure relate generally to wireless communication systems, and more particularly, to performing uplink timing control to reduce call drop.

2. Background

Wireless communication networks are widely deployed to provide various communication services such as telephony, video, data, messaging, broadcasts, and so on. Such networks, which are usually multiple access networks, support communications for multiple users by sharing the available network resources. One example of such a network is the Universal Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). The UMTS, which is the successor to Global System for Mobile Communications (GSM) technologies, currently supports various air interface standards, such as Wideband-Code Division Multiple Access (W-CDMA), Time Division-Code Division Multiple Access (TD-CDMA), and Time Division-Synchronous Code Division Multiple Access (TD-SCDMA). For example, China is pursuing TD-SCDMA as the underlying air interface in the UTRAN architecture with its existing GSM infrastructure as the core network. The UMTS also supports enhanced 3G data communications protocols, such as High Speed Packet Access (HSPA), which provides higher data transfer speeds and capacity to associated UMTS networks. HSPA is a collection of two mobile telephony protocols, High Speed Downlink Packet Access (HSDPA) and High Speed Uplink Packet Access (HSUPA) that extends and improves the performance of existing wideband protocols.

As the demand for mobile broadband access continues to increase, research and development continue to advance the UMTS technologies not only to meet the growing demand for mobile broadband access, but to advance and enhance the user experience with mobile communications.

### SUMMARY

According to one aspect of the present disclosure, a method for wireless communication includes receiving commands to change a timing advance value. The method may also include declaring an error condition. The error condition may be declared when a timing advance value compared with a reference timing advance value changes more than a threshold amount during a specified time period.

According to another aspect of the present disclosure, an apparatus for wireless communication includes means for receiving commands to change a timing advance value. The apparatus may also include means for declaring an error condition. The error condition declaring means may declare an error condition when a timing advance value compared with a reference timing advance value changes more than a threshold amount during a specified time period.

According to yet one aspect of the present disclosure, a computer program product for wireless communication in a wireless network includes a computer readable medium having non-transitory program code recorded thereon. The program code includes program code to receive commands to change a timing advance value. The program code also includes program code to declare an error condition. The error condition may be declared when a timing advance value compared with a reference timing advance value changes more than a threshold amount during a specified time period.

According to still another aspect of the present disclosure, an apparatus for wireless communication includes a memory and a processor(s) coupled to the memory. The processor(s) is configured to receive commands to change a timing advance value. The processor(s) is further configured to declare an error condition. The error condition may be declared when a timing advance value compared with a reference timing advance value changes more than a threshold amount during a specified time period.

This has outlined, rather broadly, the features and technical advantages of the present disclosure in order that the detailed description that follows may be better understood. Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

FIG. 1 is a block diagram conceptually illustrating an example of a telecommunications system.

FIG. 2 is a block diagram conceptually illustrating an example of a frame structure in a telecommunications system.

FIG. 3 is a block diagram conceptually illustrating an example of a node B in communication with a UE in a telecommunications system.

FIG. 4 illustrates a communication system in which a base station attempts to control a user equipment camped on a different cell from the cell indicated by the base station according to some aspects of the present disclosure.

FIG. 5 is a subframe time line illustrating a timing advance drift detection implementation according to some aspects of the present disclosure.

FIG. 6 is a block diagram illustrating a method for performing uplink timing control according to an aspect of the present disclosure.

FIG. 7 is a diagram illustrating an example of a hardware implementation for an apparatus employing a processing system according to one aspect of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

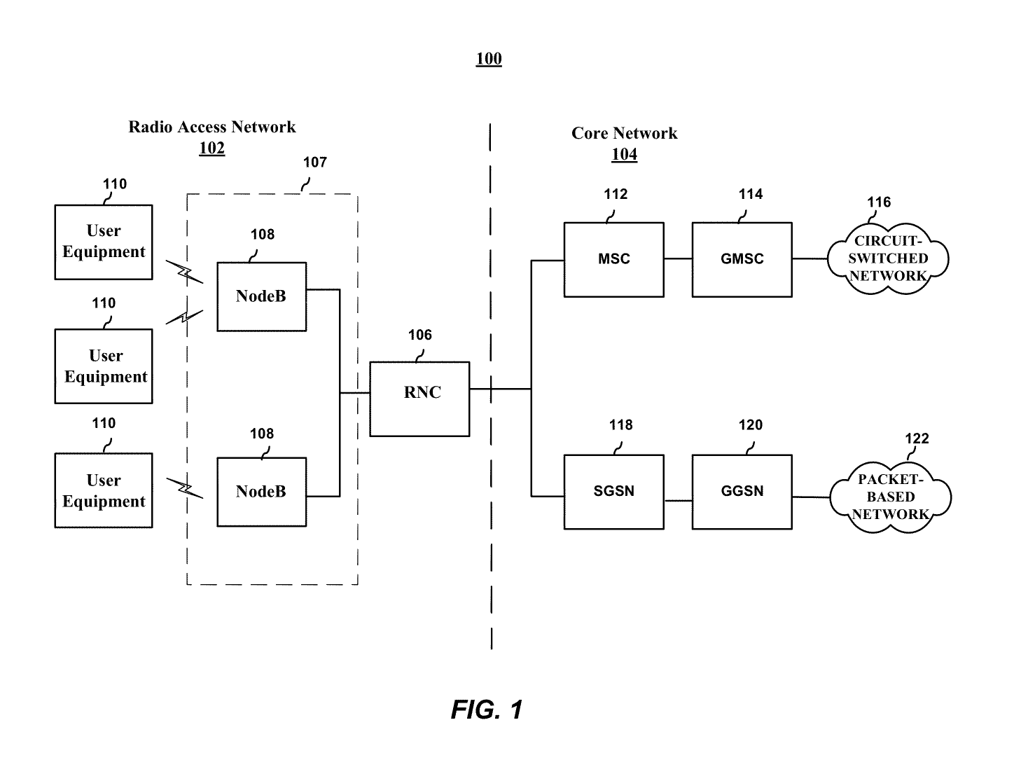

Turning now to FIG. 1, a block diagram is shown illustrating an example of a telecommunications system 100. The various concepts presented throughout this disclosure may be implemented across a broad variety of telecommunication systems, network architectures, and communication standards. By way of example and without limitation, the aspects of the present disclosure illustrated in FIG. 1 are presented with reference to a UMTS system employing a TD-SCDMA standard. In this example, the UMTS system includes a (radio access network) RAN 102 (e.g., UTRAN) that provides various wireless services including telephony, video, data, messaging, broadcasts, and/or other services. The RAN 102 may be divided into a number of Radio Network Subsystems (RNSs) such as an RNS 107, each controlled by a Radio Network Controller (RNC) such as an RNC 106. For clarity, only the RNC 106 and the RNS 107 are shown; however, the RAN 102 may include any number of RNCs and RNSs in addition to the RNC 106 and RNS 107. The RNC 106 is an apparatus responsible for, among other things, assigning, reconfiguring and releasing radio resources within the RNS 107. The RNC 106 may be interconnected to other RNCs (not shown) in the RAN 102 through various types of interfaces such as a direct physical connection, a virtual network, or the like, using any suitable transport network.

The geographic region covered by the RNS 107 may be divided into a number of cells, with a radio transceiver apparatus serving each cell. A radio transceiver apparatus is commonly referred to as a node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, two node Bs 108 are shown; however, the RNS 107 may include any number of wireless node Bs. The node Bs 108 provide wireless access points to a core network 104 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus is commonly referred to as user equipment (UE) in UMTS applications, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. For illustrative purposes, three UEs 110 are shown in communication with the node Bs 108. The downlink (DL), also called the forward link, refers to the communication link from a node B to a UE, and the uplink (UL), also called the reverse link, refers to the communication link from a UE to a node B.

The core network 104, as shown, includes a GSM core network. However, as those skilled in the art will recognize, the various concepts presented throughout this disclosure may be implemented in a RAN, or other suitable access network, to provide UEs with access to types of core networks other than GSM networks.

In this example, the core network 104 supports circuit-switched services with a mobile switching center (MSC) 112 and a gateway MSC (GMSC) 114. One or more RNCs, such as the RNC 106, may be connected to the MSC 112. The MSC 112 is an apparatus that controls call setup, call routing, and UE mobility functions. The MSC 112 also includes a visitor location register (VLR) (not shown) that contains subscriber-related information for the duration that a UE is in the coverage area of the MSC 112. The GMSC 114 provides a gateway through the MSC 112 for the UE to access a circuit-switched network 116. The GMSC 114 includes a home location register (HLR) (not shown) containing subscriber data, such as the data reflecting the details of the services to which a particular user has subscribed. The HLR is also associated with an authentication center (AuC) that contains subscriber-specific authentication data. When a call is received for a particular UE, the GMSC 114 queries the HLR to determine the UE's location and forwards the call to the particular MSC serving that location.

The core network 104 also supports packet-data services with a serving GPRS support node (SGSN) 118 and a gateway GPRS support node (GGSN) 120. GPRS, which stands for General Packet Radio Service, is designed to provide packet-data services at speeds higher than those available with standard GSM circuit-switched data services. The GGSN 120 provides a connection for the RAN 102 to a packet-based network 122. The packet-based network 122 may be the Internet, a private data network, or some other suitable packet-based network. The primary function of the GGSN 120 is to provide the UEs 110 with packet-based network connectivity. Data packets are transferred between the GGSN 120 and the UEs 110 through the SGSN 118, which performs primarily the same functions in the packet-based domain as the MSC 112 performs in the circuit-switched domain.

The UMTS air interface is a spread spectrum Direct-Sequence Code Division Multiple Access (DS-CDMA) system. The spread spectrum DS-CDMA spreads user data over a much wider bandwidth through multiplication by a sequence of pseudorandom bits called chips. The TD-SCDMA standard is based on such direct sequence spread spectrum technology and additionally calls for a time division duplexing (TDD), rather than a frequency division duplexing (FDD) as used in many FDD mode UMTS/W-CDMA systems. TDD uses the same carrier frequency for both the uplink (UL) and downlink (DL) between a node B 108 and a UE 110, but divides uplink and downlink transmissions into different time slots in the carrier.

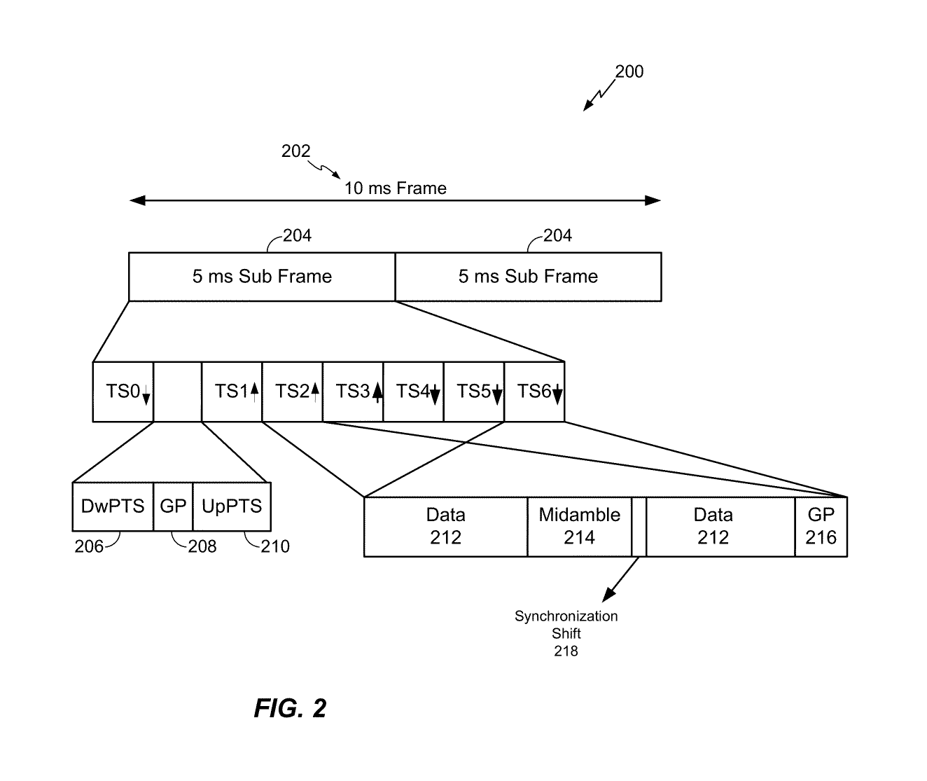

FIG. 2 shows a frame structure 200 for a TD-SCDMA carrier. The TD-SCDMA carrier, as illustrated, has a frame 202 that is 10 ms in length. The chip rate in TD-SCDMA is 1.28 Mcps. The frame 202 has two 5 ms subframes 204, and each of the subframes 204 includes seven time slots, TS0 through TS6. The first time slot, TS0, is usually allocated for downlink communication, while the second time slot, TS1, is usually allocated for uplink communication. The remaining time slots, TS2 through TS6, may be used for either uplink or downlink, which allows for greater flexibility during times of higher data transmission times in either the uplink or downlink directions. A downlink pilot time slot (DwPTS) 206, a guard period (GP) 208, and an uplink pilot time slot (UpPTS) 210 (also known as the uplink pilot channel (UpPCH)) are located between TS0 and TS1. Each time slot, TS0-TS6, may allow data transmission multiplexed on a maximum of 16 code channels. Data transmission on a code channel includes two data portions 212 (each with a length of 352 chips) separated by a midamble 214 (with a length of 144 chips) and followed by a guard period (GP) 216 (with a length of 16 chips). The midamble 214 may be used for features, such as channel estimation, while the guard period 216 may be used to avoid inter-burst interference. Also transmitted in the data portion is some Layer 1 control information, including Synchronization Shift (SS) bits 218. Synchronization Shift bits 218 only appear in the second part of the data portion. The Synchronization Shift bits 218 immediately following the midamble can indicate three cases: decrease shift, increase shift, or do nothing in the upload transmit timing. The positions of the SS bits 218 are not generally used during uplink communications.

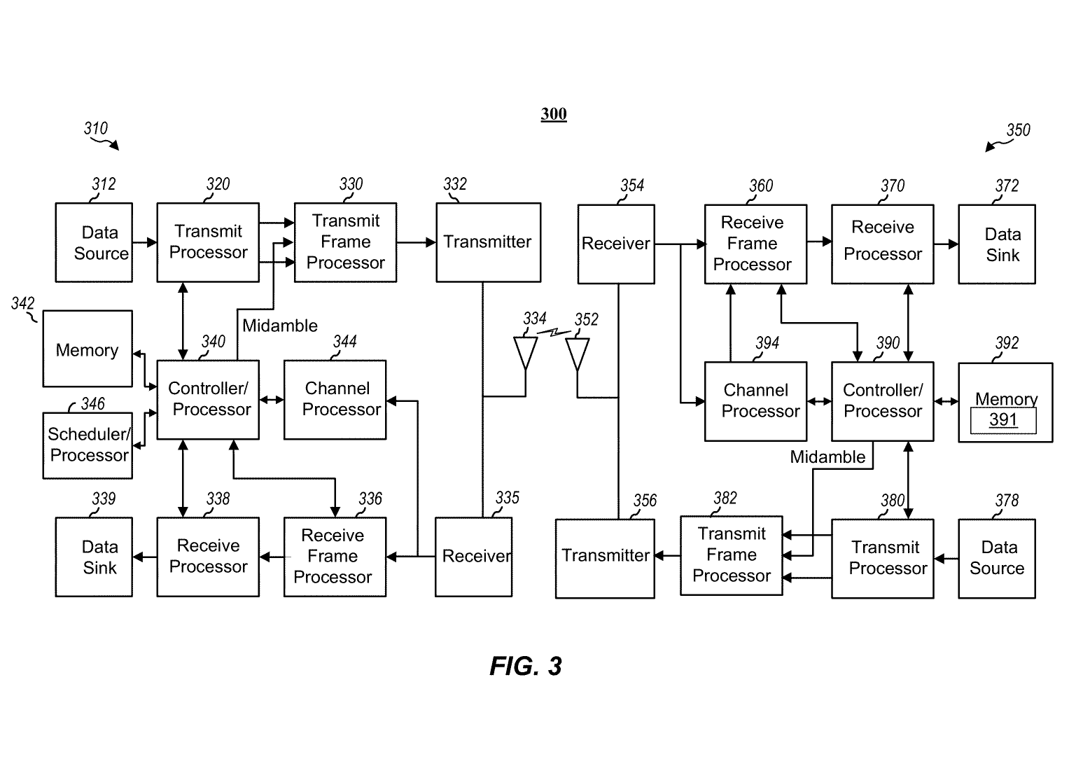

FIG. 3 is a block diagram of a node B 310 in communication with a UE 350 in a RAN 300, where the RAN 300 may be the RAN 102 in FIG. 1, the node B 310 may be the node B 108 in FIG. 1, and the UE 350 may be the UE 110 in FIG. 1. In the downlink communication, a transmit processor 320 may receive data from a data source 312 and control signals from a controller/processor 340. The transmit processor 320 provides various signal processing functions for the data and control signals, as well as reference signals (e.g., pilot signals). For example, the transmit processor 320 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 344 may be used by a controller/processor 340 to determine the coding, modulation, spreading, and/or scrambling schemes for the transmit processor 320. These channel estimates may be derived from a reference signal transmitted by the UE 350 or from feedback contained in the midamble 214 (FIG. 2) from the UE 350. The symbols generated by the transmit processor 320 are provided to a transmit frame processor 330 to create a frame structure. The transmit frame processor 330 creates this frame structure by multiplexing the symbols with a midamble 214 (FIG. 2) from the controller/processor 340, resulting in a series of frames. The frames are then provided to a transmitter 332, which provides various signal conditioning functions including amplifying, filtering, and modulating the frames onto a carrier for downlink transmission over the wireless medium through smart antennas 334. The smart antennas 334 may be implemented with beam steering bidirectional adaptive antenna arrays or other similar beam technologies.

At the UE 350, a receiver 354 receives the downlink transmission through an antenna 352 and processes the transmission to recover the information modulated onto the carrier. The information recovered by the receiver 354 is provided to a receive frame processor 360, which parses each frame, and provides the midamble 214 (FIG. 2) to a channel processor 394 and the data, control, and reference signals to a receive processor 370. The receive processor 370 then performs the inverse of the processing performed by the transmit processor 320 in the node B 310. More specifically, the receive processor 370 descrambles and despreads the symbols, and then determines the most likely signal constellation points transmitted by the node B 310 based on the modulation scheme. These soft decisions may be based on channel estimates computed by the channel processor 394. The soft decisions are then decoded and deinterleaved to recover the data, control, and reference signals. The CRC codes are then checked to determine whether the frames were successfully decoded. The data carried by the successfully decoded frames will then be provided to a data sink 372, which represents applications running in the UE 350 and/or various user interfaces (e.g., display). Control signals carried by successfully decoded frames will be provided to a controller/processor 390. When frames are unsuccessfully decoded by the receiver processor 370, the controller/processor 390 may also use an acknowledgement (ACK) and/or negative acknowledgement (NACK) protocol to support retransmission requests for those frames.

In the uplink, data from a data source 378 and control signals from the controller/processor 390 are provided to a transmit processor 380. The data source 378 may represent applications running in the UE 350 and various user interfaces (e.g., keyboard). Similar to the functionality described in connection with the downlink transmission by the node B 310, the transmit processor 380 provides various signal processing functions including CRC codes, coding and interleaving to facilitate FEC, mapping to signal constellations, spreading with OVSFs, and scrambling to produce a series of symbols. Channel estimates, derived by the channel processor 394 from a reference signal transmitted by the node B 310 or from feedback contained in the midamble transmitted by the node B 310, may be used to select the appropriate coding, modulation, spreading, and/or scrambling schemes. The symbols produced by the transmit processor 380 will be provided to a transmit frame processor 382 to create a frame structure. The transmit frame processor 382 creates this frame structure by multiplexing the symbols with a midamble 214 (FIG. 2) from the controller/processor 390, resulting in a series of frames. The frames are then provided to a transmitter 356, which provides various signal conditioning functions including amplification, filtering, and modulating the frames onto a carrier for uplink transmission over the wireless medium through the antenna 352.

The uplink transmission is processed at the node B 310 in a manner similar to that described in connection with the receiver function at the UE 350. A receiver 335 receives the uplink transmission through the antenna 334 and processes the transmission to recover the information modulated onto the carrier. The information recovered by the receiver 335 is provided to a receive frame processor 336, which parses each frame, and provides the midamble 214 (FIG. 2) to the channel processor 344 and the data, control, and reference signals to a receive processor 338. The receive processor 338 performs the inverse of the processing performed by the transmit processor 380 in the UE 350. The data and control signals carried by the successfully decoded frames may then be provided to a data sink 339 and the controller/processor, respectively. If some of the frames were unsuccessfully decoded by the receive processor, the controller/processor 340 may also use an acknowledgement (ACK) and/or negative acknowledgement (NACK) protocol to support retransmission requests for those frames.

The controller/processors 340 and 390 may be used to direct the operation at the node B 310 and the UE 350, respectively. For example, the controller/processors 340 and 390 may provide various functions including timing, peripheral interfaces, voltage regulation, power management, and other control functions. The computer readable media of memories 342 and 392 may store data and software for the node B 310 and the UE 350, respectively. For example, the memory 392 of the UE 350 may store an uplink timing control module 391 which, when executed by the controller/processor 390, configures the UE 350 for determining an expected synchronization channel code word based on the operating frequency and base station identification code of a base station. A scheduler/processor 346 at the node B 310 may be used to allocate resources to the UEs and schedule downlink and/or uplink transmissions for the UEs.

### Uplink Timing Control to Reduce Call Drop

Communication over a network may be based on timing information communicated between the base station and the user equipment (UE). For example, timing control commands (e.g., timing advance commands) may be communicated between the base station and the UE to adjust a timing advance associated with the UE. Timing advance indicates timing of transmission of an uplink subframe relative to downlink reception timing. The timing advance commands may be communicated between the base station and the UE to adjust (e.g., advance or delay) a timing advance value that allows the communication between a network and the UE to be synchronized. However, in some circumstances, repeatedly receiving timing advance commands to repeatedly adjust the timing advance value in a particular direction to synchronize the communications may eventually lead to a catastrophic event or an error condition. The error condition may eventually cause a dropped call or distortions in communication if the error condition persists. For example, a network may attempt to control a UE of interest, which is in a different cell from the cell indicated by the network. Because the UE is currently controlled by a base station in a different cell, the UE cannot comply with the commands from the network. As a result, the network will continue to send commands in one direction to instruct the UE of interest to repeatedly adjust the timing advance value in an effort to synchronize the communication with the UE. Because the timing advance commands are not configured for the UE, the UE may fail to decode the commands and/or fail to provide a coherent response to the network. However, the UE may continue to adjusts the timing advance value, which adjusts the time of transmission of the communication subframe, e.g., uplink subframe. Repeatedly adjusting the timing of the communication subframe eventually results in the error condition.

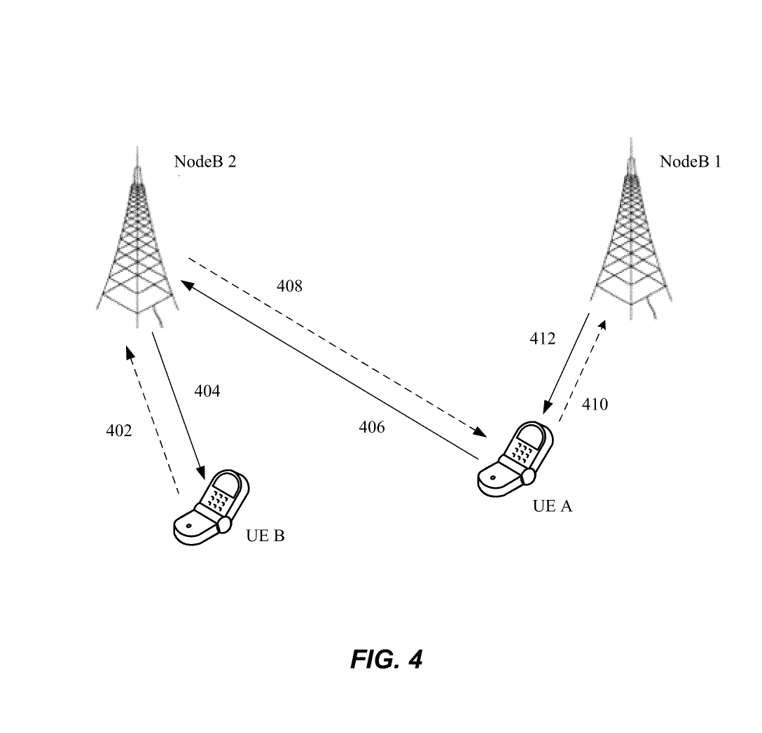

FIG. 4 illustrates a communication system in which a base station (e.g., NodeB 2) attempts to control a user equipment (e.g., UE A) camped on a different cell from the cell indicated by the base station. Base station, Node B1, may be configured to serve UE A, while Node B2 is configured to serve UE B. Accordingly, Node B2 may communicate (e.g., transmit communication commands) to UE B, or vice versa, via a downlink 404 and/or an uplink 402. Similarly, Node B1 may communicate with UE A, or vice versa, via a downlink 412 and/or an uplink 410.

Although, NodeB 2 is currently configured to serve UE B, NodeB 2 may attempt to also control UE A even though UE A is being served by NodeB 1. This attempt by Node B2 to control UE A may be due to flawed network planning where NodeB 2 and NodeB 1 are configured to operate on a same frequency. Accordingly, NodeB 2 attempts to control UE A because UE A and NodeB 2 are operating at the same frequency. As a result, UE A may receive timing advance commands intended for UE B, via a downlink 408. Because Node B2 is not configured to serve UE A, UE A cannot decode the UE B commands that originate from NodeB 2.

Similarly, UE A may attempt to communicate with NodeB 2 via an uplink 406. NodeB 2 may transmit a synchronization shift (SS) command (e.g., timing advance command) on the downlink 408. The timing advance command transmitted by the NodeB 2 and received by UE A may be intended for UE B. Nevertheless, UE A may attempt to decode the timing advance command. Because the timing advance command is not intended for UE A, UE A may fail to decode the timing advance command and fail to provide a response to the network regarding the timing advance command. For example, UE A may not send an acknowledgement (ACK)/negative acknowledgement (NACK) to NodeB 2 in response to the received timing advance command from NodeB 2. As a result, NodeB 2 assumes that UE A failed to receive the timing advance command and retransmits the timing advance command. The retransmitted timing advance command, however, may be retransmitted to UE B on the downlink 404 and/or to UE A on the downlink 408. Retransmitting the timing advance command may be repeated several times so long as UE A continuously fails to provide a response to NodeB 2 regarding reception and decoding of the timing advance command. As a result, UE B repeatedly receives these timing advance commands that instruct UE B to adjust the timing advance value to facilitate communication with NodeB 2.

UE B, which is configured to decode the timing advance commands from NodeB 2, adjust its timing advance value every time UE B receives a timing advance command from NodeB 2. For example, UE B adjusts the timing advance value to repeatedly adjust the timing of transmission of an uplink subframe. Continuously adjusting the timing of transmission of the uplink subframe, however, may eventually result in a loss of the communication signal of UE B. For example, the communication signal may fall out of a tolerance/tracking window of time for reception of the communication signal (i.e., at NodeB 1, which controls UE B) due to the continuous adjustment of the timing advance value in one direction. That is, UE B and NodeB 2 may become out of sync with respect to each other. Repeatedly adjusting the timing advance value can result in an error condition. Therefore, there is a desire to prevent or at least mitigate the effects of the error condition.

Aspects of the present disclosure include a timing advance drift detection to detect the error condition during communication based on a timing advance report. The error condition may be declared when a timing advance value drifts beyond a threshold value or fails to meet the threshold value. In some aspects of the present disclosure, the drift of the timing advance value may be tracked with respect to a nominal value of timing advance. The features of this implementation may be applied during a steady state of communication. For example, the timing advance drift detection may be applied during a steady state of a call, where the steady state may be achieved at some time interval after the call is set up or after a handoff is initiated. During the steady state, a nominal timing advance value is initialized at a desirable time. The nominal timing advance value may represent a reference point from which a drift in the timing advance value may be tracked. For example, the nominal value of timing advance may correspond to the current timing advance value after the time interval (e.g., one second=200 subframes) after the beginning of the call or after handoff of the UE from a serving cell to a target cell. The drift in the timing advance value from the nominal timing advance, which may correspond to a difference between the current timing advance value and the nominal timing advance value, is tracked.

When the timing advance value drifts beyond a threshold value, an error condition is declared. In one aspect of the disclosure, declaring the error condition may be based on comparing the drift in the timing advance value against a threshold value. The threshold value may be based on a realistic value of the timing advance that may be encountered in the realistic situations. The realistic value of the timing advance may be based on a clock drift of a modem associated with the UE and a Doppler frequency. The Doppler frequency may indicate how fast the UE moves toward or away from a base station. Similarly, the choice of threshold value may be based on downlink/uplink timing advance drift as well as a Doppler shift or indication of how fast the UE moves toward or away from the base station.

In one aspect of the disclosure, timing advance drift detection may be suspended in some instances, such as immediately after a call set-up or immediately after a cell update/handover. Suspending the timing advance drift detection during these instances may reduce false detection of an error condition due to adjustments of the UE timing by the network during these periods. The timing advance drift detection may be resumed when a steady state is achieved.

In one aspect of the present disclosure, a rate of the timing advance value may be compared to a rate of the realistic value of the timing advance to determine whether to declare the error condition. In this aspect, the declaration of the error condition is based on the rate of the timing advance drift rather than an absolute change in timing advance. Declaring the error condition based on the rate of timing advance, rather than an absolute value, accounts for the error condition as well as continuous command changes from the network, which results from a UE moving toward or away from the network.

In one aspect of the disclosure, when the error condition is declared, the timing advance is maintained (or frozen) at the current timing advance, while ignoring continuous timing advance commands from the network to adjust the timing advance value. Freezing the timing advance value at the current value when the error condition is detected, halts the continuous adjustment of the timing advance value in one direction. As a result, dropped calls or the degradation in communications may be mitigated. In this aspect, the continuous timing advance commands from the network are ignored or the timing advance value of the communication is frozen in spite of the continuous timing advance commands from the network.

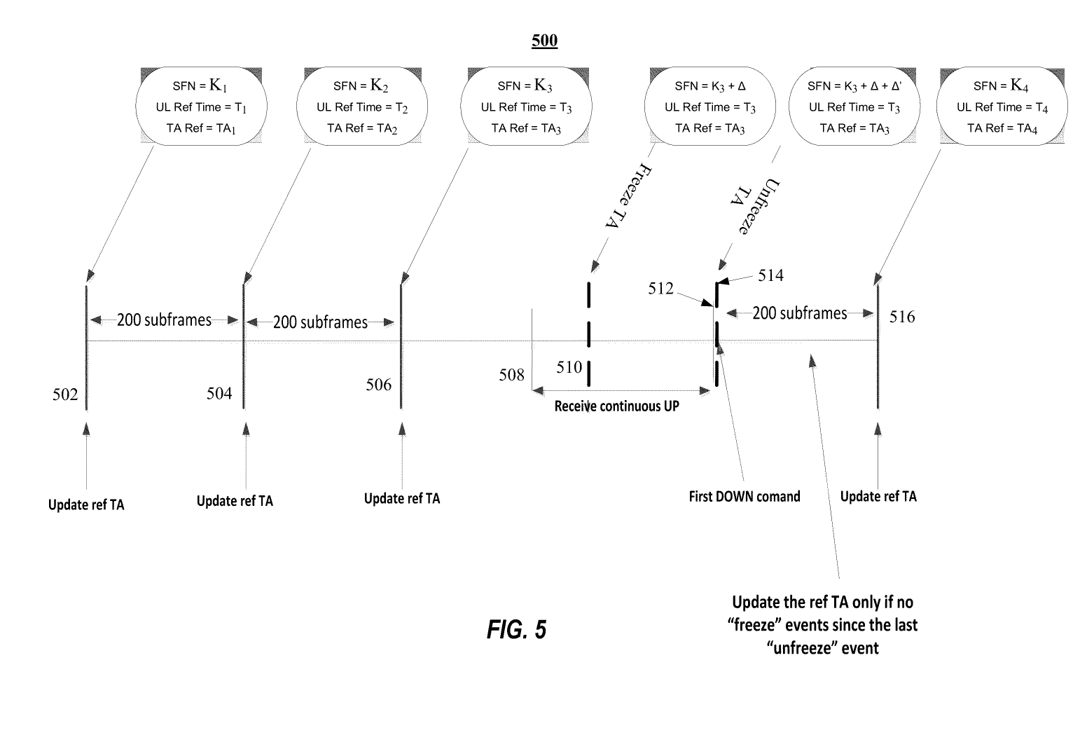

In one aspect of the disclosure, the timing advance drift detection to declare the error condition may be based on an absolute change in uplink timing with respect to an initial timing advance value as illustrated in FIG. 5. Although FIG. 5 is described with respect to an absolute change in timing advance values, the timing advance drift detection is equally applicable when a rate of the timing advance value is compared to a rate of the realistic value of the timing advance to determine whether to declare the error condition.

FIG. 5 is a subframe time line 500 illustrating a timing advance drift detection according to some aspects of the present disclosure. When a steady state of a call is achieved, a nominal timing advance value is initialized at a desirable time. The desirable time may correspond to a first position 502 on the subframe time line 500. The first position 502 is associated with a subframe in a radio frame that has a system frame number (SFN) of K₁. Similarly, the subframe time line 500 also includes other positions 504, 506 and 516 on the subframe timeline 500 that correspond to system frame numbers K₂, K₃ and K₄. The system frame number (SFN) represents the specific frame number of the frames in time. The nominal timing advance value may represent a reference point from which a drift in the timing advance value may be tracked. For example, a nominal timing advance value at the first position 502 corresponds to a current timing advance reference TA₁. Similarly, the nominal timing advance values at the other positions 504, 506 and 516 correspond to those current timing advance references TA₂, TA₃, TA₄, etc.

In one aspect of the disclosure, a reference time at which the nominal timing advance value is initialized is noted. This reference time may correspond to an uplink reference time. For example, the reference time corresponding to the first position 502 is the uplink reference time T₁. Similarly, the reference times at other positions 504, 506 and 516 on the subframe timeline 500 may correspond to uplink reference times T₂, T₃ and T₄.

In a first implementation, the nominal timing advance value may be initialized to the current timing advance value after the steady state is achieved. The steady state may be achieved one second or 200 subframes after the beginning of a call, or one second after a handoff. For example, at the first position 502, the nominal timing advance value corresponds to a timing advance reference TA₁, which corresponds to a current timing advance value at position 502 after the steady state is achieved.

The timing advance drift detection at position 504, which may be 200 subframes or one second from position 502 on the subframe timeline 500, may be based on a comparison of the nominal timing advance value at position 502 and the current timing advance value at position 504. For example, at position 504, an absolute value of the of the difference between the current timing advance value TA₂ at position 504 and a present nominal timing advance value, e.g., TA₁, may be compared against a threshold value. The difference represents the timing advance drift at position 504. As noted, the timing advance drift detection may also be accomplished by evaluating the rate of the timing advance drift rather than the absolute change.

The nominal timing advance value at position 504 may be updated or reinitialized to the current timing advance value (i.e., TA₂) when the absolute value of the difference between the current timing advance value TA₂ and the present nominal timing advance value, e.g., TA₁ fails to meet the threshold value. For example, the difference may be compared to the threshold value of two chips. If the difference is not greater than two chips, the nominal timing advance value at position 504 is reinitialized to TA₂. In this example, the error condition is not declared by the timing advance drift detection when the difference is not greater than two chips.

Similarly, the nominal timing advance value at position 506 may be reinitialized to the current timing advance value (i.e., TA₃) when the absolute value of the difference between the current timing advance value TA₃ and the present nominal timing advance value, TA₂, fails to meet the threshold value. If the difference is not greater than two chips, the nominal timing advance value at position 506, which is 200 subframes from position 504, is reinitialized to TA₃. The error condition is not declared by the timing advance drift detection when the difference is not greater than two chips.

When the absolute value of the difference between a current timing advance value, e.g., at position 510, and a present nominal timing advance value TA₃ is greater than the threshold value (e.g., 2 chips) the timing advance drift detection declares an error condition and freezes the timing advance value at the present nominal timing advance value TA₃. This feature may correspond to the reception of repeated timing advance commands starting at position 508, instructing the UE to repeatedly adjust timing of an uplink. For example, the timing advance value may gradually increase from the time of the initial reception of the timing advance commands at position 508. As noted, when the difference exceeds the threshold value at position 510, the timing advance drift detection declares an error condition and freezes the timing advance value at the present nominal timing advance value TA₃. The present nominal timing advance value TA₃ is maintained or frozen so long as the network continues to send timing advance commands in one direction, to instruct the UE of interest to repeatedly adjust the timing advance value. The timing advance drift detection may incorporate a timing control loop to facilitate freezing the timing advance value when the difference meets the threshold. Accordingly, the timing control loop may be frozen when the difference meets the threshold. In one aspect, UE transmit power is controlled during the freeze. For example, power control commands could be overridden to ensure transmit power does not drop. For example, HOLD or UP commands could be used.

When the UE stops receiving timing advance commands in one direction at position 512, the timing advance value is unfrozen shortly thereafter at position 514. For example, the timing control loop is unfrozen the first time the UE receives timing advance commands in an opposite direction relative to the direction that resulted in the error condition. In one aspect of the disclosure, the present nominal timing advance value TA₃ may be used to evaluate further error conditions. For example, present nominal timing advance value TA₃ may be used to evaluate error conditions at position 516 or any other future positions.

When the absolute value of the difference between a current timing advance value TA₄, e.g., at position 516, and the present nominal timing advance value TA₃ is not greater than the threshold value within one second or 200 subframes from initialization or a last unfrozen state, the nominal timing advance value, e.g., at position 516, is reinitialized to the current timing advance value (i.e., TA₄). That is, the control loop continues to the next position and compares the difference to the threshold value as in previous positions.

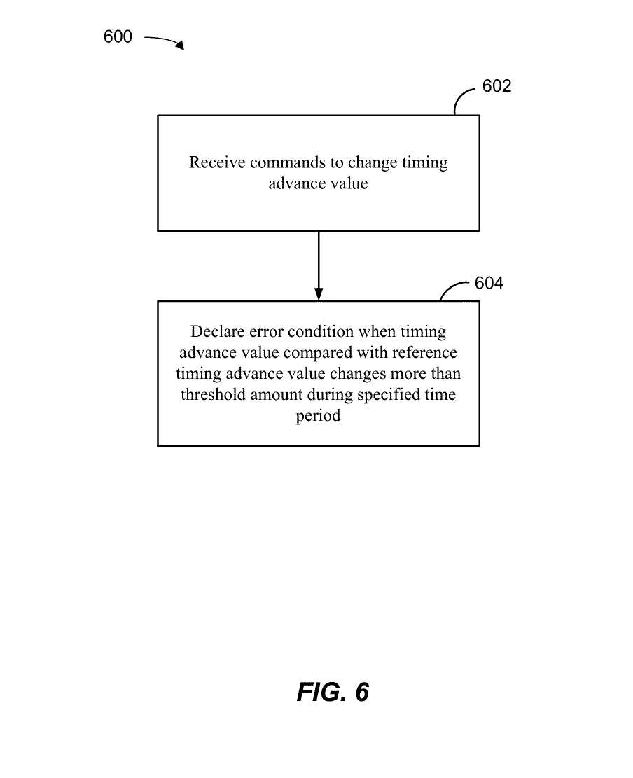

FIG. 6 shows a wireless communication method according to one aspect of the disclosure. A UE may receive commands to change a timing advance value, as shown in block 602. The UE may declare an error condition when a timing advance value compared with a reference timing advance value changes more than a threshold amount during a specified time period, as shown in block 604. In another aspect, absolute movement of the uplink timing is monitored, in addition to relative timing with respect to the downlink.

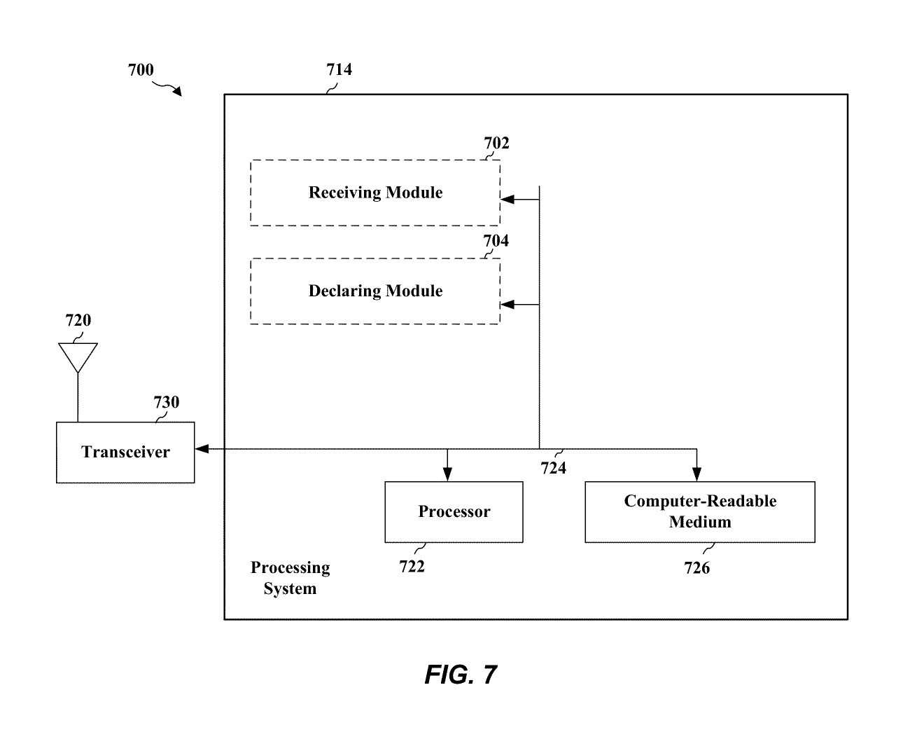

FIG. 7 is a diagram illustrating an example of a hardware implementation for an apparatus 700 employing a processing system 714. The processing system 714 may be implemented with a bus architecture, represented generally by the bus 724. The bus 724 may include any number of interconnecting buses and bridges depending on the specific application of the processing system 714 and the overall design constraints. The bus 724 links together various circuits including one or more processors and/or hardware modules, represented by the processor 722 the modules 702, and 704, and the computer-readable medium 726. The bus 724 may also link various other circuits such as timing sources, peripherals, voltage regulators, and power management circuits, which are well known in the art, and therefore, will not be described any further.

The apparatus includes a processing system 714 coupled to a transceiver 730. The transceiver 730 is coupled to one or more antennas 720. The transceiver 730 enables communicating with various other apparatus over a transmission medium. The processing system 714 includes a processor 722 coupled to a computer-readable medium 726. The processor 722 is responsible for general processing, including the execution of software stored on the computer-readable medium 726. The software, when executed by the processor 722, causes the processing system 714 to perform the various functions described for any particular apparatus. The computer-readable medium 726 may also be used for storing data that is manipulated by the processor 722 when executing software.

The processing system 714 includes a receiving module 702 for receiving commands to change a timing advance value. The processing system 714 includes a declaring module 704 for declaring an error condition when a timing advance value compared with a reference timing advance value changes more than a threshold amount during a specified time period. The modules may be software modules running in the processor 722, resident/stored in the computer-readable medium 726, one or more hardware modules coupled to the processor 722, or some combination thereof. The processing system 714 may be a component of the UE 350 and may include the memory 392, and/or the controller/processor 390.

In one configuration, an apparatus such as the processing system is configured for wireless communication including means for means for receiving commands to change a timing advance value. In one aspect, the above means may be the receiving module 702, transceiver 730, antenna 720, 352, receiver 354, uplink timing control module 391, controller/processor 390, memory 392, processor 722, and/or the processing system 714 configured to perform the functions recited by the aforementioned means. In another aspect, the aforementioned means may be a module or any apparatus configured to perform the functions recited by the aforementioned means.

In one configuration, an apparatus such as the processing system is configured for wireless communication including means for declaring an error condition when a timing advance value compared with a reference timing advance value changes more than a threshold amount during a specified time period. In one aspect, the above means may be the processor 722, uplink timing control module 391, memory 392, controller/processor 390, and/or the processing system 714 configured to perform the functions recited by the aforementioned means. In another aspect, the aforementioned means may be a module or any apparatus configured to perform the functions recited by the aforementioned means.

In one configuration, an apparatus such as a UE is configured for wireless communication including means for declaring. In one aspect, the above means may be the controller/processor 390, the memory 392, uplink timing control module 391, the declaring module 704, and/or the processing system 714 configured to perform the functions recited by the aforementioned means. In another aspect, the aforementioned means may be a module or any apparatus configured to perform the functions recited by the aforementioned means.

Several aspects of a telecommunications system has been presented with reference to TD-SCDMA systems. As those skilled in the art will readily appreciate, various aspects described throughout this disclosure may be extended to other telecommunication systems, network architectures and communication standards. By way of example, various aspects may be extended to other UMTS systems such as W-CDMA, High Speed Downlink Packet Access (HSDPA), High Speed Uplink Packet Access (HSUPA), High Speed Packet Access Plus (HSPA+) and TD-CDMA. Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Several processors have been described in connection with various apparatuses and methods. These processors may be implemented using electronic hardware, computer software, or any combination thereof. Whether such processors are implemented as hardware or software will depend upon the particular application and overall design constraints imposed on the system. By way of example, a processor, any portion of a processor, or any combination of processors presented in this disclosure may be implemented with a microprocessor, microcontroller, digital signal processor (DSP), a field-programmable gate array (FPGA), a programmable logic device (PLD), a state machine, gated logic, discrete hardware circuits, and other suitable processing components configured to perform the various functions described throughout this disclosure. The functionality of a processor, any portion of a processor, or any combination of processors presented in this disclosure may be implemented with software being executed by a microprocessor, microcontroller, DSP, or other suitable platform.

Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. A computer-readable medium may include, by way of example, memory such as a magnetic storage device (e.g., hard disk, floppy disk, magnetic strip), an optical disk (e.g., compact disc (CD), digital versatile disc (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, or a removable disk. Although memory is shown separate from the processors in the various aspects presented throughout this disclosure, the memory may be internal to the processors (e.g., cache or register).

Computer-readable media may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

1. A method of wireless communication, comprising:
receiving commands to change a timing advance value; and
declaring an error condition when a timing advance value compared with a reference timing advance value changes more than a threshold amount during a specified time period.

2. The method of claim 1, further comprising holding a current time advance value upon declaring the error condition.

3. The method of claim 1, further comprising recovering from the error condition when a current command includes a timing advance value having a direction different from a direction of a previously received timing advance value.

4. The method of claim 3, further comprising maintaining the reference timing advance value.

5. The method of claim 1, further comprising updating the reference timing advance value when another error is not declared within a reset period.

6. The method of claim 1, further comprising holding or increasing a transmission power upon declaring the error condition.

7. The method of claim 1, in which the change in the timing advance value is measured after a certain period following initialization.

8. The method of claim 7, in which initialization comprises handover, initialization of a new call, or channel resource reconfiguration.

9. An apparatus for wireless communication, comprising:
means for receiving commands to change a timing advance value; and
means for declaring an error condition when a timing advance value compared with a reference timing advance value changes more than a threshold amount during a specified time period.

10. The apparatus of claim 9, further comprising means for recovering from the error condition when a current command includes a timing advance value having a direction different from a direction of a previously received timing advance value.

11. An apparatus for wireless communication, comprising:
a memory; and
at least one processor coupled to the memory and configured:
to receive commands to change a timing advance value; and
to declare an error condition when a timing advance value compared with a reference timing advance value changes more than a threshold amount during a specified time period.

12. The apparatus of claim 11, in which the at least one processor is further configured to hold a current time advance value upon declaring the error condition.

13. The apparatus of claim 11, in which the at least one processor is further configured to recover from the error condition when a current command includes a timing advance value having a direction different from a direction of a previously received timing advance value.

14. The apparatus of claim 13, in which the at least one processor is further configured to maintain the reference timing advance value.

15. The apparatus of claim 11, in which the at least one processor is further configured to update the reference timing advance value when another error is not declared within a reset period.

16. The apparatus of claim 11, in which the at least one processor is further configured to hold or increase a transmission power upon declaring the error condition.

17. The apparatus of claim 11, in which the change in the timing advance value is measured after a certain period following initialization.

18. The apparatus of claim 17, in which initialization comprises handover, initialization of a new call, or channel resource reconfiguration.

19. A computer program product for wireless communications in a wireless network, comprising:
a non-transitory computer-readable medium having program code recorded thereon, the program code comprising:
program code to receive commands to change a timing advance value; and
program code to declare an error condition when a timing advance value compared with a reference timing advance value changes more than a threshold amount during a specified time period.

20. The computer program product of claim 19, in which the program code further comprises code to recover from the error condition when a current command includes a timing advance value having a direction different from a direction of a previously received timing advance value.
